(19) United States
(12) Patent Application Publication
(10) Pub. No.: US 2021/0312456 A1
(43) Pub. Date: Oct. 7, 2021

(54) System, Method, and Computer Program Product for Merchant Breach Detection Using Convolutional Neural Networks

(71) Applicant: Visa International Service Association, San Francisco, CA (US)

(72) Inventors: Shi Cao, Austin, TX (US); Shubham Agrawal, Round Rock, TX (US); Chiranjeet Chetia, Round Rock, TX (US); Claudia Carolina Barcenas Cardenas, Austin, TX (US); David Stoddard Lambertson, Seattle, WA (US); Beatrice-Atena Faurescu, San Ramon, CA (US)

(21) Appl. No.: 17/218,811

(22) Filed: Mar. 31, 2021

Related U.S. Application Data
(60) Provisional application No. 63/003,479, filed on Apr. 1, 2020.

(51) Int. Cl. G06Q 20/40; G06N 3/02

(52) U.S. Cl. CPC G06Q 20/4016; G06N 3/02

(57) ABSTRACT

Described are a system, method, and computer program product for merchant breach detection using convolutional neural networks. The method includes receiving transaction data associated with a plurality of transactions by a plurality of payment devices in a first time period subsequent to the plurality of payment devices transacting with a merchant. The method also includes identifying, based on inputting at least one parameter of the transaction data into a fraud evaluation model, a set of suspected fraudulent transactions of the plurality of transactions. The method further includes generating an image comprising a field of points, wherein each point of the field of points is associated with at least one transaction. The method further includes detecting breach of the merchant by processing the image with a convolutional neural network (CNN) model.

### CROSS-REFERENCE TO RELATED APPLICATION

This application claims priority to U.S. Provisional Patent Application No. 63/003,479, titled “System, Method, and Computer Program Product for Merchant Breach Detection Using Convolutional Neural Networks,” filed Apr. 1, 2020, the disclosure of which is hereby incorporated by reference in its entirety.

### BACKGROUND

### 1. Technical Field

Disclosed embodiments or aspects relate generally to fraud detection systems, and, in one particular embodiment or aspect, to a system, method, and computer program product for merchant breach detection using convolutional neural network analysis of processed transaction data.

### 2. Technical Considerations

Merchant breach (e.g., data security vulnerability) detection and fraud mitigation is a challenging problem due to the extreme imbalance of data. The ratio of breached merchants to non-breached merchants may be as low as 1:100,000. Only about a few hundred confirmed breach cases per year yields largely insufficient data by which to train merchant-comparison breach detection models. Machine learning or other statistical methods for detecting breach typically require a large volume of samples as input, e.g., for a training data set. It may be difficult to extract common features from only a few hundred confirmed cases to develop a general breach detection rule or model for merchants.

Furthermore, current breach detection systems are often slow and reactionary to actual instances of confirmed fraud as reported by consumers. A high number of transactions may continue to occur at a breached merchant before a traditional breach detection system identifies the breach.

There is a need in the art for a technically improved breach detection system to identify merchant breach earlier after a breach event to reduce the number of post-breach transactions. There is a further need in the art for a reliable, automated method of detecting breach in merchants so that security countermeasures may be accurately and promptly enabled.

### SUMMARY

Accordingly, and generally, provided is an improved system, method, and computer program product for merchant breach detection using convolutional neural networks (CNNs).

According to non-limiting embodiments or aspects, provided is a computer-implemented method for merchant breach detection using CNNs. The method includes receiving, with at least one processor, transaction data associated with a plurality of transactions by a plurality of payment devices in a first time period subsequent to the plurality of payment devices transacting with a merchant. The method also includes identifying, with at least one processor, based on inputting at least one parameter of the transaction data into a fraud evaluation model, a set of suspected fraudulent transactions of the plurality of transactions. The method further includes generating, with at least one processor, an image including a field of points, wherein each point of the field of points is associated with at least one transaction of the set of suspected fraudulent transactions, and wherein an x-axis position in the image of each point in the field of points is associated with a time subperiod of the first time period in which the at least one transaction occurred. The method further includes detecting, with at least one processor, breach of the merchant by processing the image with a convolutional neural network (CNN) model.

In further non-limiting embodiments or aspects, the at least one parameter may include at least one of the following: chargeback data; reported fraud data; decline data; or any combination thereof.

In further non-limiting embodiments or aspects, a y-axis position in the image of each point in the field of points may be associated with an index of a payment device of the plurality of payment devices. The method may also include generating, with at least one processor, a plurality of permuted images by randomly altering indexes of the plurality of payment devices for each of the plurality of permuted images to rearrange the y-axis position of each point in a field of points of each of the plurality of permuted images. The method may further include detecting, with at least one processor, the breach of the merchant by processing each of the plurality of permuted images with the CNN model.

In further non-limiting embodiments or aspects, detecting the breach of the merchant may further include assigning a breach likelihood score to the image using the CNN model and comparing the breach likelihood score to a threshold score generated from evaluations of transaction data from previous time periods and other merchants. The method may further include generating, with at least one processor, display data configured to cause a computing device to display a user interface depicting the breach likelihood score, the image visually adjacent a time scale, and a visual indicator of where in the image the breach occurred. The method may further include communicating, with at least one processor, the display data to a computing device of the merchant.

In further non-limiting embodiments or aspects, the method may also include, in response to detecting the breach of the merchant, initiating, with at least one processor, a network security countermeasure including at least one of the following: declining transactions with the merchant; freezing at least one transaction account associated with at least one payment device of the plurality of payment devices; communicating alerts to users of the plurality of payment devices; or any combination thereof.

In further non-limiting embodiments or aspects, an intensity value of each point of the field of points may be based on a number of suspected fraudulent transactions associated with a payment device having occurred in a given time subperiod.

According to non-limiting embodiments or aspects, provided is a system including a server including at least one processor. The server is programmed and/or configured to receive transaction data associated with a plurality of transactions by a plurality of payment devices in a first time period subsequent to the plurality of payment devices transacting with a merchant. The server is programmed and/or configured to identify, based on inputting at least one parameter of the transaction data into a fraud evaluation model, a set of suspected fraudulent transactions of the plurality of transactions. The server is programmed and/or configured to generate an image including a field of points, wherein each point of the field of points is associated with at least one transaction of the set of suspected fraudulent transactions, and wherein an x-axis position in the image of each point in the field of points is associated with a time subperiod of the first time period in which the at least one transaction occurred. The server is programmed and/or configured to detect breach of the merchant by processing the image with a convolutional neural network (CNN) model.

In further non-limiting embodiments or aspects, a y-axis position in the image of each point in the field of points may be associated with an index of a payment device of the plurality of payment devices. The server may be further programmed and/or configured to generate a plurality of permuted images by randomly altering indexes of the plurality of payment devices for each of the plurality of permuted images to rearrange the y-axis position of each point in a field of points of each of the plurality of permuted images. The server may be further programmed and/or configured to detect the breach of the merchant by processing each of the plurality of permuted images with the CNN model.

In further non-limiting embodiments or aspects, detecting the breach of the merchant may include assigning a breach likelihood score to the image using the CNN model and comparing the breach likelihood score to a threshold score generated from evaluations of transaction data from previous time periods and other merchants. The server may be further programmed and/or configured to generate display data configured to cause a computing device to display a user interface depicting the breach likelihood score, the image visually adjacent a time scale, and a visual indicator of where in the image the breach occurred. The server may be further programmed and/or configured to communicate the display data to a computing device of the merchant.

In further non-limiting embodiments or aspects, the server may be further programmed and/or configured to, in response to detecting the breach of the merchant, initiate a network security countermeasure including at least one of the following: declining transactions with the merchant; freezing at least one transaction account associated with at least one payment device of the plurality of payment devices; communicating alerts to users of the plurality of payment devices; or any combination thereof.

According to non-limiting embodiments or aspects, provided is a computer program product including at least one non-transitory computer-readable medium including program instructions that, when executed by at least one processor, cause the at least one processor to receive transaction data associated with a plurality of transactions by a plurality of payment devices in a first time period subsequent to the plurality of payment devices transacting with a merchant. The program instructions cause the at least one processor to identify, based on inputting at least one parameter of the transaction data into a fraud evaluation model, a set of suspected fraudulent transactions of the plurality of transactions. The program instructions cause the at least one processor to generate an image including a field of points, wherein each point of the field of points is associated with at least one transaction of the set of suspected fraudulent transactions, and wherein an x-axis position in the image of each point in the field of points is associated with a time subperiod of the first time period in which the at least one transaction occurred. The program instructions cause the at least one processor to detect breach of the merchant by processing the image with a convolutional neural network (CNN) model.

In further non-limiting embodiments or aspects, a y-axis position in the image of each point in the field of points may be associated with an index of a payment device of the plurality of payment devices. The program instructions may further cause the at least one processor to generate a plurality of permuted images by randomly altering indexes of the plurality of payment devices for each of the plurality of permuted images to rearrange the y-axis position of each point in a field of points of each of the plurality of permuted images. The program instructions may further cause the at least one processor to detect the breach of the merchant by processing each of the plurality of permuted images with the CNN model.

In further non-limiting embodiments or aspects, detecting the breach of the merchant further may include assigning a breach likelihood score to the image using the CNN model and comparing the breach likelihood score to a threshold score generated from evaluations of transaction data from previous time periods and other merchants. The program instructions may further cause the at least one processor to generate display data configured to cause a computing device to display a user interface depicting the breach likelihood score, the image visually adjacent a time scale, and a visual indicator of where in the image the breach occurred. The program instructions may further cause the at least one processor to communicate the display data to a computing device of the merchant.

In further non-limiting embodiments or aspects, the program instructions may further cause the at least one processor to, in response to detecting the breach of the merchant, initiate a network security countermeasure including at least one of the following: declining transactions with the merchant; freezing at least one transaction account associated with at least one payment device of the plurality of payment devices; communicating alerts to users of the plurality of payment devices; or any combination thereof.

Other non-limiting embodiments or aspects of the present disclosure will be set forth in the following numbered clauses:

Clause 1: A computer-implemented method comprising: receiving, with at least one processor, transaction data associated with a plurality of transactions by a plurality of payment devices in a first time period subsequent to the plurality of payment devices transacting with a merchant; identifying, with at least one processor, based on inputting at least one parameter of the transaction data into a fraud evaluation model, a set of suspected fraudulent transactions of the plurality of transactions; generating, with at least one processor, an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and detecting, with at least one processor, breach of the merchant by processing the image with a convolutional neural network (CNN) model.

Clause 2: The computer-implemented method of clause 1, wherein the at least one parameter comprises at least one of the following: chargeback data; reported fraud data; decline data; or any combination thereof.

Clause 3: The computer-implemented method of clause 1 or 2, wherein a y-axis position in the image of each point in the field of points is associated with an index of a payment device of the plurality of payment devices.

Clause 4: The computer-implemented method of any of clauses 1-3, further comprising: generating, with at least one processor, a plurality of permuted images by randomly altering indexes of the plurality of payment devices for each of the plurality of permuted images, to rearrange the y-axis position of each point in the field of points of each of the plurality of permuted images; and detecting, with at least one processor, the breach of the merchant by processing each of the plurality of permuted images with the CNN model.

Clause 5: The computer-implemented method of any of clauses 1-4, wherein detecting the breach of the merchant further comprises assigning a breach likelihood score to the image using the CNN model and comparing the breach likelihood score to a threshold score generated from evaluations of transaction data from previous time periods and other merchants.

Clause 6: The computer-implemented method of any of clauses 1-5, further comprising: generating, with at least one processor, display data configured to cause a computing device to display a user interface depicting the breach likelihood score, the image visually adjacent a time scale, and a visual indicator of where in the image the breach occurred; and communicating, with at least one processor, the display data to a computing device of the merchant.

Clause 7: The computer-implemented method of any of clauses 1-6, further comprising, in response to detecting the breach of the merchant, initiating, with at least one processor, a network security countermeasure comprising at least one of the following: declining transactions with the merchant; freezing at least one transaction account associated with at least one payment device of the plurality of payment devices; communicating alerts to users of the plurality of payment devices; or any combination thereof.

Clause 8: The computer-implemented method of any of clauses 1-7, wherein an intensity value of each point of the field of points is based on a number of suspected fraudulent transactions associated with a payment device having occurred in a given time subperiod.

Clause 9: A system comprising a server comprising at least one processor, the server being programmed and/or configured to: receive transaction data associated with a plurality of transactions by a plurality of payment devices in a first time period subsequent to the plurality of payment devices transacting with a merchant; identify, based on inputting at least one parameter of the transaction data into a fraud evaluation model, a set of suspected fraudulent transactions of the plurality of transactions; generate an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and detect breach of the merchant by processing the image with a convolutional neural network (CNN) model.

Clause 10: The system of clause 9, wherein a y-axis position in the image of each point in the field of points is associated with an index of a payment device of the plurality of payment devices.

Clause 11: The system of clause 9 or 10, wherein the server is further programmed and/or configured to: generate a plurality of permuted images by randomly altering indexes of the plurality of payment devices for each of the plurality of permuted images, to rearrange the y-axis position of each point in the field of points of each of the plurality of permuted images; and detect the breach of the merchant by processing each of the plurality of permuted images with the CNN model.

Clause 12: The system of any of clauses 9-11, wherein detecting the breach of the merchant further comprises assigning a breach likelihood score to the image using the CNN model and comparing the breach likelihood score to a threshold score generated from evaluations of transaction data from previous time periods and other merchants.

Clause 13: The system of any of clauses 9-12, wherein the server is further programmed and/or configured to: generate display data configured to cause a computing device to display a user interface depicting the breach likelihood score, the image visually adjacent a time scale, and a visual indicator of where in the image the breach occurred; and communicate the display data to a computing device of the merchant.

Clause 14: The system of any of clauses 9-13, wherein the server is further programmed and/or configured to, in response to detecting the breach of the merchant, initiate a network security countermeasure comprising at least one of the following: declining transactions with the merchant; freezing at least one transaction account associated with at least one payment device of the plurality of payment devices; communicating alerts to users of the plurality of payment devices; or any combination thereof.

Clause 15: A computer program product comprising at least one non-transitory computer-readable medium including program instructions that, when executed by at least one processor, cause the at least one processor to: receive transaction data associated with a plurality of transactions by a plurality of payment devices in a first time period subsequent to the plurality of payment devices transacting with a merchant; identify, based on inputting at least one parameter of the transaction data into a fraud evaluation model, a set of suspected fraudulent transactions of the plurality of transactions; generate an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and detect breach of the merchant by processing the image with a convolutional neural network (CNN) model.

Clause 16: The computer program product of clause 15, wherein a y-axis position in the image of each point in the field of points is associated with an index of a payment device of the plurality of payment devices.

Clause 17: The computer program product of clause 15 or 16, wherein the program instructions further cause the at least one processor to: generate a plurality of permuted images by randomly altering indexes of the plurality of payment devices for each of the plurality of permuted images, to rearrange the y-axis position of each point in the field of points of each of the plurality of permuted images; and detect the breach of the merchant by processing each of the plurality of permuted images with the CNN model.

Clause 18: The computer program product of any of clauses 15-17, wherein detecting the breach of the merchant further comprises assigning a breach likelihood score to the image using the CNN model and comparing the breach likelihood score to a threshold score generated from evaluations of transaction data from previous time periods and other merchants.

Clause 19: The computer program product of any of clauses 15-18, wherein the program instructions further cause the at least one processor to: generate display data configured to cause a computing device to display a user interface depicting the breach likelihood score, the image visually adjacent a time scale, and a visual indicator of where in the image the breach occurred; and communicate the display data to a computing device of the merchant.

Clause 20: The computer program product of any of clauses 15-19, wherein the program instructions further cause the at least one processor to, in response to detecting the breach of the merchant, initiate a network security countermeasure comprising at least one of the following: declining transactions with the merchant; freezing at least one transaction account associated with at least one payment device of the plurality of payment devices; communicating alerts to users of the plurality of payment devices; or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of non-limiting embodiments or aspects of an environment in which systems, apparatuses, and/or methods, as described herein, may be implemented;

FIG. 2 is a diagram of non-limiting embodiments or aspects of components of one or more devices of FIG. 1;

FIG. 3 is a flow diagram of non-limiting embodiments or aspects of a method for merchant breach detection using convolutional neural networks;

FIG. 4 is a flow diagram of non-limiting embodiments or aspects of a method for merchant breach detection using convolutional neural networks;

FIG. 5 is an illustrative diagram of non-limiting embodiments or aspects of a method for merchant breach detection using convolutional neural networks;

FIG. 6 is an illustrative diagram of non-limiting embodiments or aspects of a method for merchant breach detection using convolutional neural networks;

FIG. 7 is an illustrative diagram of non-limiting embodiments or aspects of a method for merchant breach detection using convolutional neural networks;

FIG. 8 is an illustrative diagram of non-limiting embodiments or aspects of evaluating the performance of described methods for merchant breach detection using convolutional neural networks; and

FIG. 9 is a flow diagram of non-limiting embodiments or aspects of a method for merchant breach detection using convolutional neural networks.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments as they are oriented in the drawing figures. However, it is to be understood that non-limiting embodiments may assume various alternative variations and step sequences, except where expressly specified to the contrary. It is also to be understood that the specific devices and processes illustrated in the attached drawings, and described in the following specification, are simply exemplary embodiments. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In non-limiting embodiments, a message may refer to a network packet (e.g., a data packet, and/or the like) that includes data. Any known electronic communication protocols and/or algorithms may be used such as, for example, TCP/IP (including HTTP and other protocols), WLAN (including 802.11 and other radio frequency-based protocols and methods), analog transmissions, cellular networks (e.g., Global System for Mobile Communications (GSM), Code Division Multiple Access (CDMA), Long-Term Evolution (LTE®), Worldwide Interoperability for Microwave Access (WiMAX®), etc.), and/or the like. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “payment device” may refer to a portable financial device, an electronic payment device, a payment card (e.g., a credit or debit card), a gift card, a smartcard, smart media, a payroll card, a healthcare card, a wrist band, a machine-readable medium containing account information, a keychain device or fob, a radio-frequency identification (RFID) transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the payment device may include volatile or non-volatile memory to store information (e.g., an account identifier, a name of the account holder, and/or the like).

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “server” or “server computer” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., POS devices, directly or indirectly communicating in the network environment may constitute a “system,” such as a merchant's POS system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to a system, method, and computer program product for merchant breach detection using convolutional neural networks (CNNs). The present disclosure provides a technical solution to the shortcomings of previous automated merchant breach detection systems, which are comparatively slower and less accurate. The present disclosure provides a unique solution of generating images from transaction data so that CNNs may be deployed to detect breach events. The present disclosure includes a more efficient and closer-to-real-time detection system by analyzing individual transactions of payment devices occurring after transacting with a target merchant and detecting deviations in the images generated from received transaction data. In this manner, a merchant's transaction history does not need to be compared to transaction histories of known breach merchants, reducing breach response time and detection accuracy. The present disclosure provides a more accurate detection system by analyzing changes in transaction behavior specific to payment devices that have interacted with the merchant. Moreover, by relying on parameters such as decline data and chargeback data, a merchant breach can be detected before consumers begin to report fraud in large enough numbers for traditional fraud systems to reach.

The described merchant breach detection processes may be used to trigger automated security countermeasures (e.g., fraud mitigation programs) and may further be useful for visually representing the likelihood of breach as a product of transaction behavior over time. Earlier and more accurate breach detection provided by disclosed systems and methods not only minimize the severity of fraud resulting from merchant breach, but it further reduces computer resource waste (e.g., processing capacity, bandwidth, number of communications) associated with fraudulent transactions and subsequent remedial measures in response to breach and fraud. Merchant breach detection is a technically difficult problem due to the potential imbalance of data. The ratio of breached merchants to non-breached merchants may be as low as 1:100,000. Therefore, with potentially only a few hundred confirmed breach cases, detection may be challenging. The described systems and methods require less data or samples as input to operate successfully.

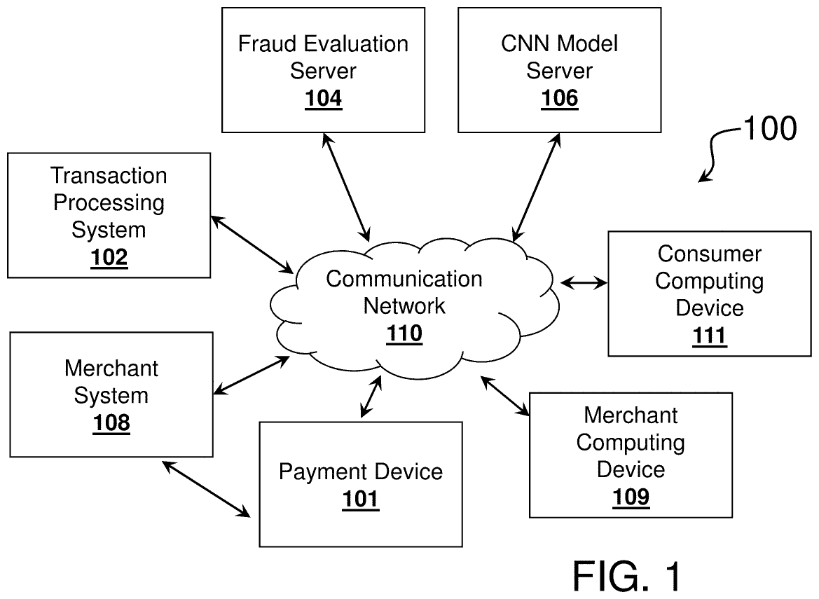

Referring now to FIG. 1, illustrated is a diagram of an example environment 100 in which devices, systems, and/or methods, described herein, may be implemented. As shown in FIG. 1, environment 100 includes one or more payment devices 101, transaction processing system 102, a fraud evaluation server 104 (e.g., associated with a transaction service provider), a convolutional neural network (CNN) model server 106 (e.g., associated with a transaction service provider), a merchant system 108, a merchant computing device 109, a consumer computing device 111, and a communication network 110.

Transaction processing system 102 may include one or more devices capable of being in communication with merchant system 108, fraud evaluation server 104, CNN model server 106, merchant computing device 109, and/or consumer computing device 111 via communication network 110. Transaction processing system 102 may include the fraud evaluation server 104 and/or the CNN model server 106. In some non-limiting embodiments or aspects, transaction processing system 102 may include one or more computing devices, such as a server, a group of servers, and/or other like devices. Said computing devices may include data storage devices, which may be local or remote to transaction processing system 102. In some non-limiting embodiments or aspects, transaction processing system 102 may be capable of receiving information from, storing information in, communicating information to, or searching information stored in the data storage device. Transaction processing system 102 may process and receive transaction data (e.g., transaction amount, time, merchant identifier, payment device identifier, transaction description, etc.) for transactions between payment devices 101 and merchants (e.g., merchant systems 108). Transaction processing system 102 may process and receive transaction data in a first time period (e.g., month, quarter of a year, six months, etc.) by a plurality of payment devices 101 subsequent to at least an initial transaction between said plurality of payment devices 101 and a merchant. In doing so, the activity of payment devices 101 after interacting with a merchant may be analyzed to determine if there has been a breach associated with the merchant.

Fraud evaluation server 104 may include one or more devices capable of being in communication with merchant system 108, transaction processing system 102, CNN model server 106, merchant computing device 109, and/or consumer computing device 111 via communication network 110. Fraud evaluation server 104 may be included in a same server or system as transaction processing system 102 and/or CNN model server 106. In some non-limiting embodiments or aspects, fraud evaluation server 104 may include one or more computing devices, such as a server, a group of servers, and/or other like devices. Said computing devices may include data storage devices, which may be local or remote to fraud evaluation server 104. In some non-limiting embodiments or aspects, fraud evaluation server 104 may be capable of receiving information from, storing information in, communicating information to, or searching information stored in the data storage device.

Fraud evaluation server 104 may be configured to identify one or more suspected fraudulent transactions from transactions processed by transaction processing system 102. Fraud evaluation server 104 may include one or more fraud evaluation models programmed and/or configured to categorize and/or score transactions according to a likelihood of fraud, such as based on one or more parameters of transaction data (e.g., chargeback data, reported fraud data, transaction decline data, abnormal values of transaction data, etc.). Fraud evaluation server 104 may generate a set of suspected fraudulent transactions based on a plurality of transactions and based on inputting at least one parameter of the transaction data into the fraud evaluation model. Fraud evaluation server 104 may further, in response to the detection of a merchant breach, initiate one or more network security countermeasures, including, but not limited to: declining transactions with the merchant that has been breached; freezing (e.g., disabling one, multiple, or all functionalities of) a transaction account (e.g., credit account, debit account, etc.) associated with a payment device; communicating one or more alerts (e.g., warning messages) to one or more consumer computing devices 111 of one or more users of one or more payment devices 101; and/or the like. Security actions involving transaction accounts may be triggered in response to communication between the fraud evaluation server 104 and an issuer system that manages the transaction account.

CNN model server 106 may include one or more devices capable of being in communication with merchant system 108, transaction processing system 102, fraud evaluation server 104, merchant computing device 109, and/or consumer computing device 111 via communication network 110. CNN model server 106 may be included in a same server or system as transaction processing system 102 and/or fraud evaluation server 104. In some non-limiting embodiments or aspects, CNN model server 106 may include one or more computing devices, such as a server, a group of servers, and/or other like devices. Said computing devices may include data storage devices, which may be local or remote to CNN model server 106. In some non-limiting embodiments or aspects, CNN model server 106 may be capable of receiving information from, storing information in, communicating information to, or searching information stored in the data storage device.

CNN model server 106 may be configured to generate an image from transaction data for merchant breach analysis. The image may include a field of points, wherein each point (e.g., pixel, localized group of pixels) of the field of points is associated with at least one transaction of the set of suspected fraudulent transactions. The image may also be generated from all processed transactions, where points representing suspected fraudulent transactions are distinguished by hue, saturation, and/or brightness. An intensity value (e.g., high or low value of hue, saturation, and/or brightness) of each point may be based on a number of suspected fraudulent transactions associated with a payment device (e.g., y-axis position) having occurred in a given time subperiod (e.g., x-axis position). A high number of suspected fraudulent transactions may be correlated with a high or low intensity value for a given point, wherein the high number of suspected fraudulent transactions is determined based on a comparison to the density of transactions associated with other points in the image. The x-axis position in the image of each point in the field of points may be associated with a time subperiod (e.g., hour, day, week, etc.) of the first time period in which the transaction occurred. The y-axis position in the image of each point in the field of points may be associated with an index of a payment device 101 associated with transactions along the y-axis position, such as including a unique y-axis position (e.g., row) for transactions of a given payment device 101. CNN model server 106 may be further configured to detect a breach of a merchant by processing the generated image using a CNN model, e.g., such as detecting groupings or patterns of points in the field of points (e.g., clusters along an x-axis position).

CNN model server 106 may further generate a plurality of permuted images by randomly altering indexes of the plurality of payment devices, to rearrange a y-axis position of each point in a field of points according to the y-axis position of the payment device index. In doing so, the permuted images may vary by having rows of points rearranged by having different y-axis positions. The CNN model may detect breach by processing each of the permuted images and determining breach by one or more of the permuted images having patterns or groupings indicative of a breach event (e.g., clusters along an x-axis position).

CNN model server 106 may detect the breach of a merchant by assigning a breach likelihood score to the analyzed image using the CNN model. Breach may be detected by comparing the assigned breach likelihood score to a threshold score generated from evaluations of transaction data from other time periods and/or other merchants (e.g., mean score, median score, etc.). If the breach likelihood score satisfies (e.g., meets and/or exceeds) the threshold score, breach may be detected. Moreover, CNN model server 106 may generate display data configured to cause a computing device to display a user interface depicting the breach likelihood score of a given image. The image may be displayed visually adjacent a time scale, including a visual indicator of where in the image (e.g., an x-axis position, an x-axis and one or more y-axis positions, etc.) the breach occurred (e.g., displaying a box, a circle, a line, an arrow, a highlight, etc.). The display data may be communicated to a merchant computing device 109.

Merchant computing device 109 may include one or more devices capable of being in communication with merchant system 108, transaction processing system 102, fraud evaluation server 104, CNN model server 106, and/or consumer computing device 111 via communication network 110. Merchant computing device 109 may be associated with a merchant system 108 and may include a display. The display may include a user interface to show breach analysis data. Merchant computing device 109 may include a display for showing a user interface to depict one or more images generated from the CNN model server 106, including display data for depicting the breach likelihood score and/or visual indicators of where breach occurred.

Consumer computing device 111 may include one or more devices capable of being in communication with merchant system 108, transaction processing system 102, fraud evaluation server 104, CNN model server 106, and/or merchant computing device 109 via communication network 110. Consumer computing device 111 may be associated with a user of a payment device and may include a display. The display may include a user interface to show alerts received from a fraud evaluation server 104. The consumer computing device 111 may further access and/or include an application (e.g., financial institution banking application, internet browser, etc.) for managing one or more transaction accounts that may be frozen in response to merchant breach events.

Communication network 110 may include one or more wired and/or wireless networks. For example, communication network 110 may include a cellular network (e.g., a long-term evolution (LTE®) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, a mesh network, a beacon network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

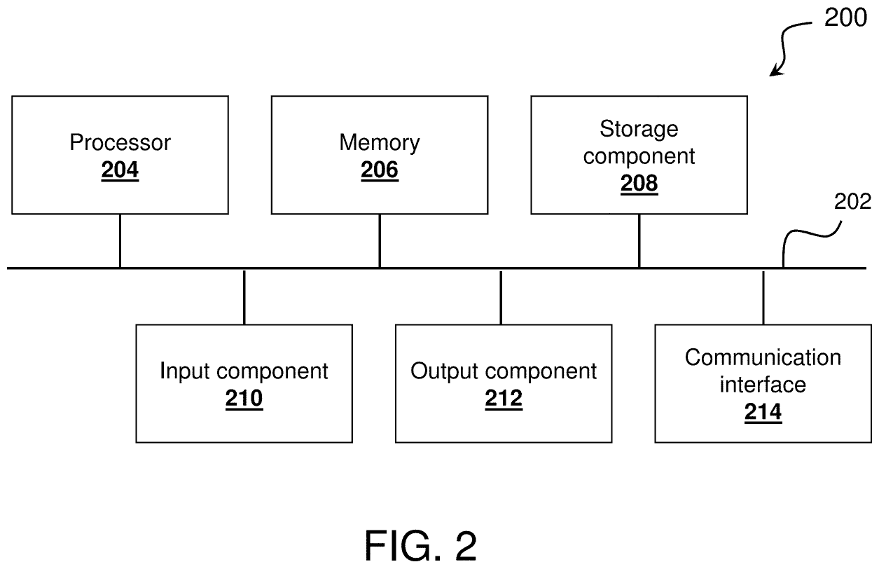

Referring now to FIG. 2, illustrated is a diagram of example components of device 200. Device 200 may correspond to one or more devices of a payment device 101, a transaction processing system 102, a fraud evaluation server 104, a CNN model server 106, a merchant system 108, a merchant computing device 109, a consumer computing device 111, and/or a communication network 110. In non-limiting embodiments or aspects, one or more devices of the foregoing may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

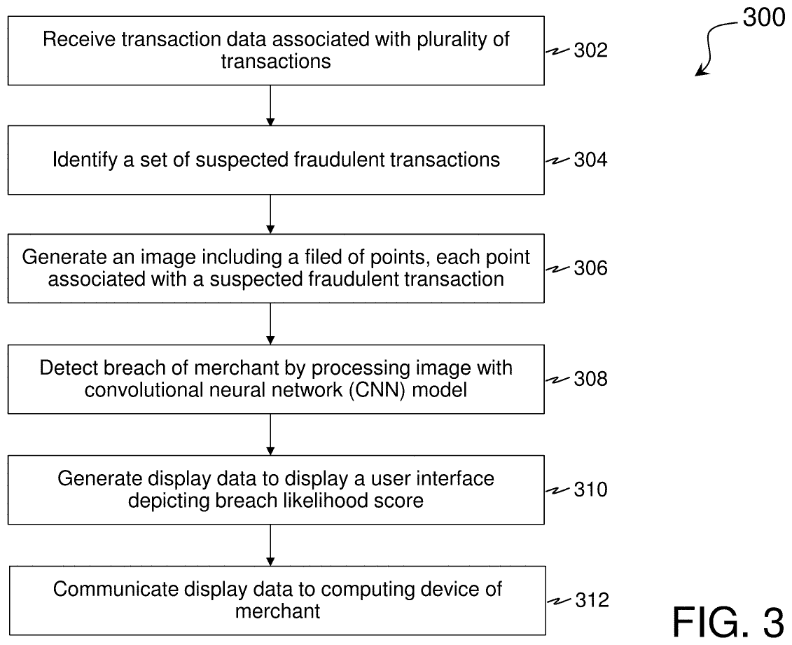

Referring now to FIG. 3, depicted is a flow diagram of non-limiting embodiments or aspects of a method 300 for merchant breach detection using convolutional neural networks. The method 300 may be executed by one or more processors of transaction processing system 102, fraud evaluation server 104, CNN model server 106, and/or other computing device. One step of method 300 may be executed by a same or different processor as another step of method 300.

In step 302, transaction data may be received. For example, transaction processing system 102 may receive transaction data associated with a plurality of transactions by a plurality of payment devices in a first time period subsequent to the plurality of payment devices transacting with a merchant. Analyzing transaction data for a plurality of payment devices in a time period subsequent to the plurality of payment devices transacting with a merchant allows for earlier and more accurate detection of merchant breach, which may avoid waste of computer resources (e.g., processing capacity, bandwidth, etc.) as a result of fraudulent transactions due to a breached merchant going undetected.

In step 304, a set of suspected fraudulent transactions may be identified. For example, fraud evaluation server 104 may identify, based on inputting one or more parameters of the transaction data into a fraud evaluation model, a set of suspected fraudulent transactions of the plurality of transactions. The fraud evaluation model may include a machine learning model trained on historic, confirmed fraudulent transaction data and may be used to detect fraudulent transactions based on one or more parameters (e.g., chargeback data, reported fraud data, decline data, abnormal values of transaction data, etc.) of the transaction data. Each transaction may be individually assigned a score of likelihood of fraud, and the score may be compared to a threshold score (e.g., generated from historic scores, such as to minimize false positives and/or false negatives). Transactions having scores that satisfy the threshold score may be included in the set of suspected fraudulent transactions.

In step 306, an image including a field of points may be generated from the transaction data. For example, the CNN model server 106 may generate an image including a field of points, where each point of the field of points is associated with at least one transaction of the set of suspected fraudulent transactions. An intensity value (e.g., of hue, saturation, and/or brightness) of each point of the field of points may be based on (e.g., proportional to) a number of suspected fraudulent transactions associated with a payment device having occurred in a given time subperiod. Moreover, an x-axis position in the image of each point in the field of points may be associated with a time subperiod of (e.g., in) the first time period in which the at least one transaction occurred. A y-axis position in the image of each point in the field of points may be associated with an index of a payment device of the plurality of payment devices with which associated transactions were completed. For example, each payment device may include a row of points of suspected fraudulent transactions having been made with the payment device.

In step 308, breach of the merchant may be detected. For example, the CNN model server 106 may detect breach of the merchant by processing the generated image with a CNN model. The CNN model may include one or more CNN machine learning algorithms trained on historic generated images of confirmed breach events, such that the CNN model may detect merchant breaches based on images having similar patterns of points. The CNN model server 106 may, to detect a breach of a merchant, generate and assign a breach likelihood score to a generated image using the CNN model, and comparing the breach likelihood score to a threshold score generated from evaluations of transaction data from previous time periods and/or other merchants.

In step 310, display data may be generated for the display of a user interface to depict breach likelihood score and/or generated images. For example, the CNN model server 106 may generate display data configured to cause a computing device to display a user interface depicting the breach likelihood score, the image visually adjacent a time scale (e.g., displayed on an x-axis), and a visual indicator of where in the image the breach occurred.

In step 312, the display data may be communicated to a computing device of a merchant. For example, the CNN model server 106 may communicate the display data to a computing device of the merchant for which breach was detected. The merchant computing device 109 of the merchant may receive the display data and display, in a user interface, the breach likelihood score, image, and visual indicator according to the display data. The merchant computing device 109 may receive or display only the image or the image and the visual indicator.

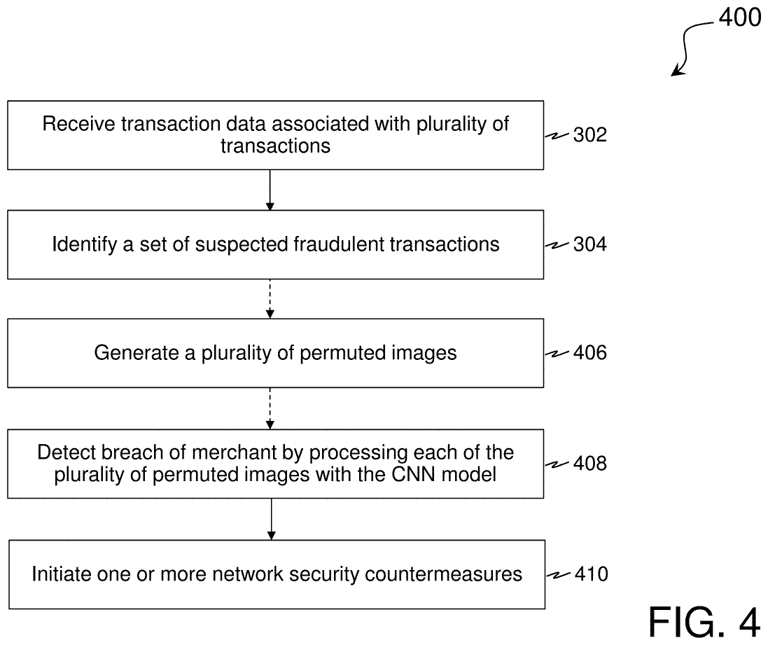

Referring now to FIG. 4, depicted is a flow diagram of non-limiting embodiments or aspects of a method 400 for merchant breach detection using convolutional neural networks. The method 400 may be executed by one or more processors of transaction processing system 102, fraud evaluation server 104, CNN model server 106, and/or other computing device. One step of method 400 may be executed by a same or different processor as another step of method 400.

In step 302, transaction data may be received. For example, transaction processing system 102 may receive transaction data associated with a plurality of transactions by a plurality of payment devices in a first time period subsequent to the plurality of payment devices transacting with a merchant.

In step 304, a set of suspected fraudulent transactions may be identified. For example, fraud evaluation server 104 may identify, based on inputting one or more parameters of the transaction data into a fraud evaluation model, a set of suspected fraudulent transactions of the plurality of transactions.

In step 406, a plurality of permuted images may be generated. For example, the CNN model server 106 may generate, in addition to or including the image generated in step 306 of FIG. 4, a plurality of permuted images by randomly altering indexes of the plurality of payment devices for each of the plurality of permuted images. In doing so, the y-axis position of each point in the field of points for each of the plurality of permuted images may be rearranged. By way of further example, each row of points corresponding to transactions of one payment device may have a different y-axis in each permuted image.

In step 408, a breach of a merchant may be detected by processing each of the plurality of permuted images with the CNN model. For example, the CNN model server 106 may detect breach of the merchant by processing each of the permuted images with the CNN model. A determination of breach may be based on one or more of the permuted images being classified as indicating breach (e.g., a likelihood of breach), by the CNN model.

In step 410, one or more network security countermeasures may be initiated. Step 410 may likewise be executed in response to the detection of breach in step 308 of FIG. 3. For example, fraud evaluation server 104 may initiate one or more network security countermeasures, including, but not limited to: declining transactions with the merchant that has been breached; freezing (e.g., disabling one, multiple, or all functionalities of) a transaction account (e.g., credit account, debit account, etc.) associated with a payment device; communicating one or more alerts (e.g., warning messages) to one or more consumer computing devices 111 of one or more users of one or more payment devices 101; and/or the like. Security actions involving transaction accounts may be triggered in response to communication between the fraud evaluation server 104 and an issuer system that manages the transaction account.

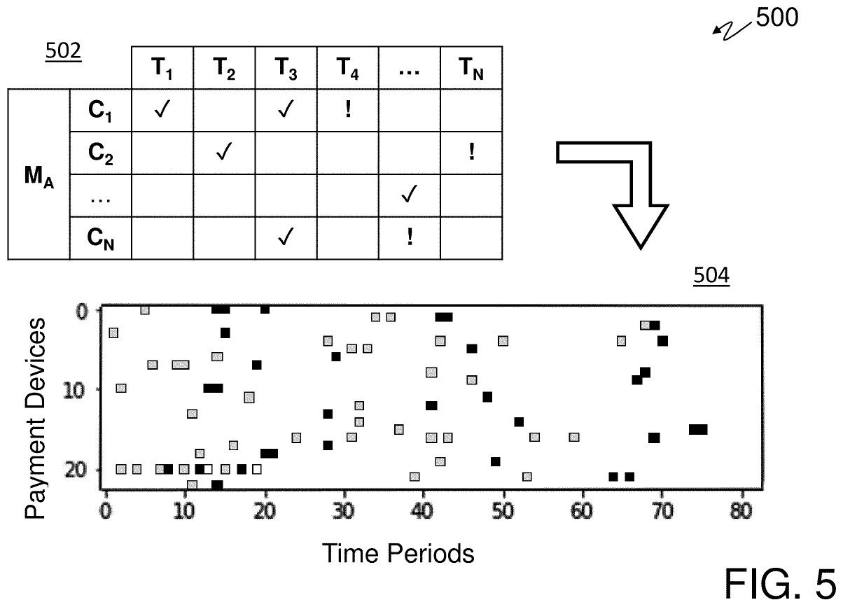

Referring now to FIG. 5, depicted is an illustrative diagram of non-limiting embodiments or aspects of a method 500 for merchant breach detection using convolutional neural networks. The method 500 may be performed by one or more processors of a CNN model server 106 or other computing device.

In step 502, received transaction data may be tabulated. For example, the CNN model server 106 may tabulate received transaction data into rows corresponding to payment devices (C₁, C₂, . . . C_{N}) and columns corresponding to time subperiods (T₁, T₂, T₃, T₄, . . . T_{N}). A cell of the tabulated data may represent a categorization for transactions completed in a given time subperiod for the payment device. For example, transactions associated with a cell may be evaluated by a fraud evaluation server 104 and may be scored based on fraud likelihood. If transactions associated with a cell are not likely to be fraudulent, the cell may be given an indicator of normal transaction behavior. As shown in step 502, cells of the table are marked with a checkmark to show normal transaction behavior. If one or more transactions associated with a cell are likely to be fraudulent, the cell may be given an indicator of abnormal transaction behavior. As shown in step 502, cells of the table are marked with an exclamation point to shown abnormal transaction behavior. It will be appreciated that an additional indicator may be used to indicate a mixture of normal and abnormal transaction behavior. The tabulated transaction data may be generated for one or more merchants.

In step 504, from the tabulated transaction behavior, an image may be generated for a given merchant. For example, the CNN model server 106 may generate an image for the merchant including a field of points. Each point may have an x-axis of time subperiod in which associated transactions were completed. Each point may have a y-axis of payment device index. The image may be generated such that only points indicative of suspected fraudulent transactions may be shown. As shown, points indicating normal transaction behavior are grey, points indicating abnormal transaction behavior are black, and points indicating a mixture of normal and abnormal transaction behavior are white. It will be appreciated that the points may be visually represented by other variations of distinctive hue, saturation, and/or brightness. It will also be appreciated that while a visible and labeled set of axes are shown for step 504, such as in a user interface, the image within the rectangle may be what is analyzed by a CNN model.

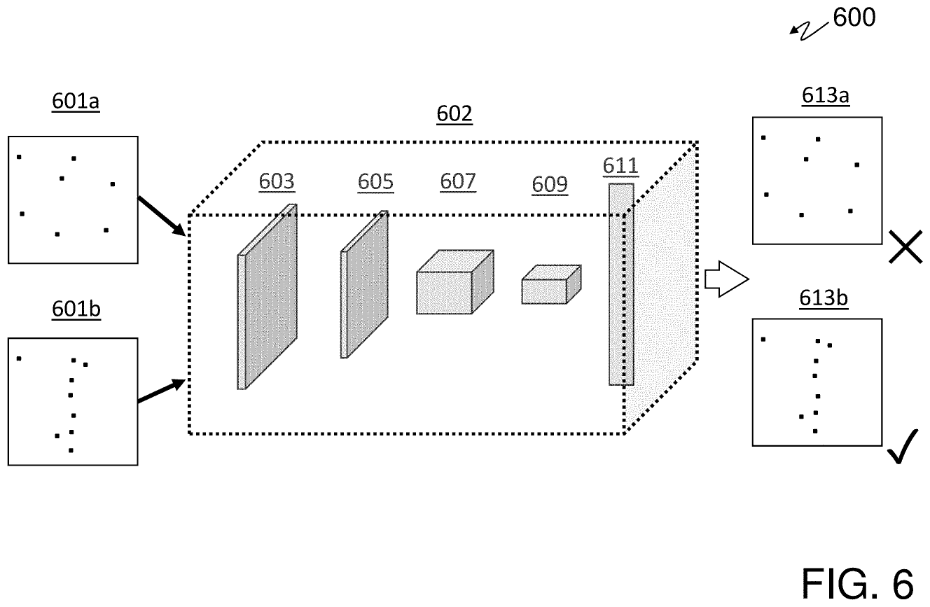

Referring now to FIG. 6, depicted is an illustrative diagram of non-limiting embodiments or aspects of a method 600 for merchant breach detection using convolutional neural networks. The method 600 may be performed by one or more processors of a CNN model server 106 or other computing device.

Layers 603, 605, 607, 609, and 611 are shown to represent an exemplary CNN model 602 for feature classification, which may be used to detect features in an image. The CNN model 602 may receive an input layer 601a, 601b. As shown, a first input layer 601a represents an image generated from a non-breach event, and a second input layer 601b represents an image generated from a breach event. Each input layer 601a, 601b may be separately classified. After the input layer 601a, 601b, the CNN model 602 may include a first convolutional layer 603 to generate a feature map of the input layer 601a, 601b. The CNN model 602 may include a first pooling layer 605 to down-sample the generated feature map by summarizing the presence of features in patches of the feature map. The CNN model 602 may further include a second convolutional layer 607 to generate a second feature map using the down-sampled first feature map as an input layer. The CNN model 602 may further include a second pooling layer 609 to down-sample the second generated feature map. Finally, the CNN model 602 may include a fully connected layer 611 to take the input volume of the second pooling layer 609 and output a dimensional vector to represent a classification. As shown, a first classification 613a of the first input layer 601a would represent a non-breach event, and a second classification 613b of the second input layer 601b would represent a breach event. It will be appreciated that other combinations of convolutional layers, pooling layers, and rectified linear unit layers may be used to generate a classification from initial input layers 601a, 601b.

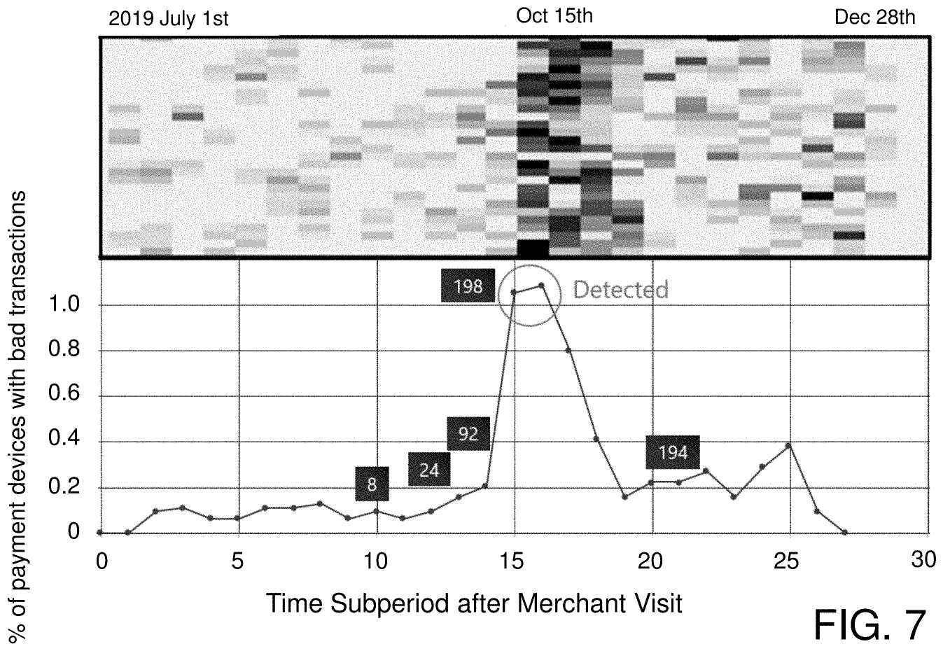

Referring now to FIG. 7, depicted is an illustrative diagram of non-limiting embodiments or aspects of a method for merchant breach detection using convolutional neural networks. Shown is an exemplary user interface that may display the results of merchant breach analysis according to systems and methods described herein. Illustrated in the top half of the user interface is an image generated by a CNN model server 106 using transaction data of a breached merchant. The image includes an accompanying timeline above to shown the evaluated time period. The image includes a field of points. As shown, the darker a point on the field of points, the higher value (e.g., number, ratio, fraud score, etc.) of fraudulent transactions associated with a payment device in a given time period. The lower half of the user interface displays a chart with a percent of payment devices having bad transactions plotted on a y-axis, and time subperiod (e.g., week) after merchant visit (e.g., time since payment device made a purchase at the merchant) plotted on the x-axis. As shown, there is a peak in percentage of payment devices having bad transactions approximately overlapping with a clustered pattern in the generated image above. The line graph includes numbers of payment devices with fraudulent transactions shown in white text on black labels along corresponding points in the line graph. The user interface further includes a visual indicator of where in the image the breach occurred, namely, a circle labeled “Detected”, which aligns with an x-axis position in the image. It will be appreciated that the visual indicator may be overlaid on the generated image itself and may include other types of indicators, including rectangles, lines, arrows, highlights, and/or the like.

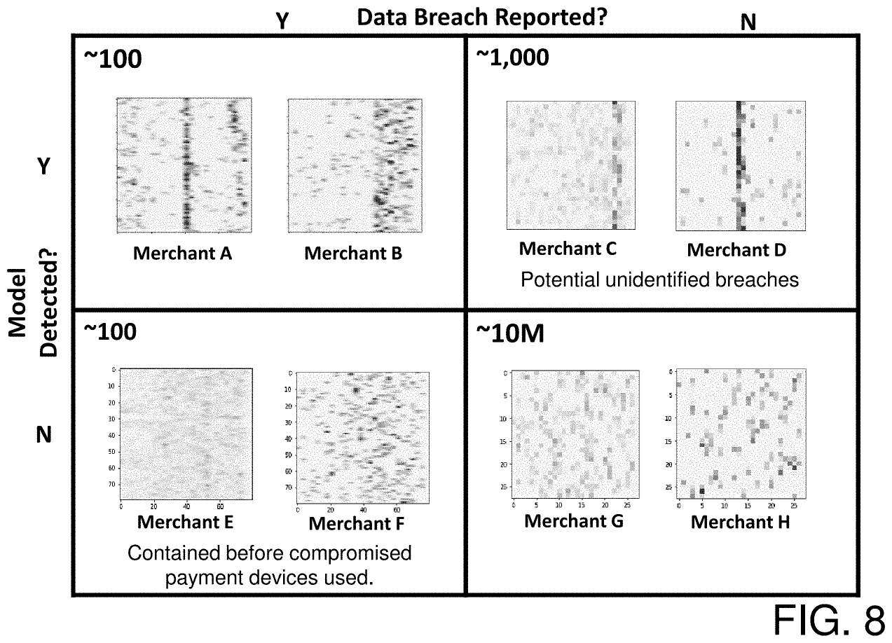

FIG. 8 is an illustrative diagram of non-limiting embodiments or aspects of evaluating the performance of described methods for merchant breach detection using convolutional neural networks. Shown is a matrix with two categories on each axis, where the y-axis represents scenarios where a tested CNN model detected a merchant breach, delineated by “yes” (Y) and “no” (N), and the x-axis represents scenarios where a data breach was actually reported, delineated by “yes” (Y) and “no” (N).

The first (upper left) quadrant represents a proportion of total analyzed merchants (approximately 100) where a data breach was reported and a CNN model server 106 successfully detected the breach. Depicted in the first quadrant are two exemplary generated images (Merchant A and Merchant B) analyzed by a CNN model server 106. The images of the first quadrant exemplify clustered patterns in the generated images that were detected by the CNN model as indicative of breach.

The second (upper right) quadrant represents a proportion of total analyzed merchants (approximately 1000) where a data breach was not reported, but the CNN model server 106 detected a breach. The second quadrant may indicate merchants where breaches went unidentified by other means, resulting in non-reported breaches. Depicted in the second quadrant are two exemplary generated images (Merchant C and Merchant D) analyzed by the CNN model server 106. The images of the second quadrant exemplify clustered patterns in the generated images that were detected by the CNN model as indicative of breach.

The third (lower left) quadrant represents a proportion of total analyzed merchants (approximately 100) where a data breach was reported, but the CNN model server 106 did not detect a breach. The third quadrant may indicate merchants that detected and contained a breach before the compromised payment devices were used by the agents associated with the breach. Depicted in the third quadrant are two exemplary generated images (Merchant E and Merchant F) analyzed by the CNN model server 106. The images of the third quadrant exemplify a lack of clustered patterns in the generated images that would have been detected by the CNN model as indicative of breach.

The fourth (lower right) quadrant represents a proportion of total analyzed merchants (approximately 10 million) where a data breach was neither reported nor detected by the CNN model server 106. Depicted in the fourth quadrant are two exemplary generated images (Merchant G and Merchant H) analyzed by the CNN model server 106. The images of the fourth quadrant exemplify a lack of clustered patterns in the generated images that would have been detected by the CNN model as indicative of breach.

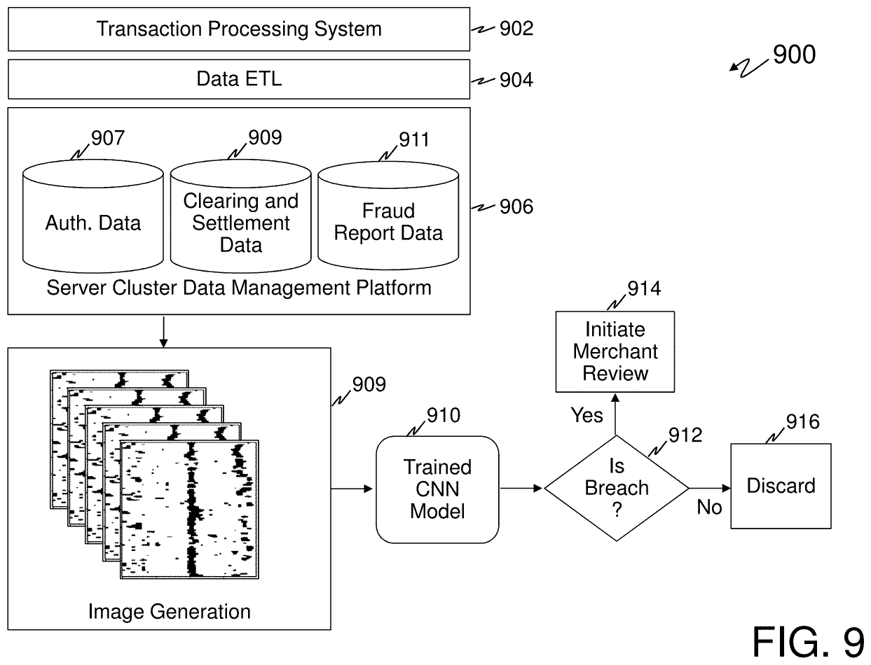

Referring now to FIG. 9, depicted is a flow diagram of non-limiting embodiments or aspects of a method 900 for merchant breach detection using convolutional neural networks. The method 900 may be executed by one or more processors of transaction processing system 102, fraud evaluation server 104, CNN model server 106, and/or other computing device. One step of method 900 may be executed by a same or different processor as another step of method 900.

In step 902, transactions may be processed. For example, the transaction processing system 102 may process transactions, thereby receiving transaction data associated with a plurality of transactions by a plurality of payment devices in a first time period subsequent to the plurality of payment devices transacting with a merchant.

In step 904, the transaction data may be extracted. For example, a data extract, transform, load (ETL) engine of a transaction processing system 102 may copy the transaction data from one or more sources into associated databases in a format for use in merchant breach detection.

In step 906, the transaction data may be distributed to a server cluster data management platform. For example, the transaction processing system 102 may include a server cluster data management platform, such as a Hadoop data lake. The server cluster data management platform may include one or more servers for storing transaction authorization data 907, transaction clearing and settlement data 909, and transaction fraud reporting data 911.

In step 909, the transaction data may be used to generate one or more images for use in breach detection. For example, a CNN model server 106 may generate one or more images for each analyzed merchant, according to the above described systems and methods. The images may be used as input layers for a CNN model, in step 910.

In step 912, based on the classification of the CNN model in step 910, a determination of breach may be made. For example, the CNN model server 106 may determine if a merchant experienced a breach based on analyzing one or more generated images for said merchant. If breach is not detected in step 912, the image may be discarded in step 916 and no further action may be taken. However, if breach is detected in step 912, then merchant review may be initiated in step 914. For example, the CNN model server 106 may generate display data configured to cause a display of a merchant computing device 109 to display a user interface including at least the generated image, for use by a merchant to evaluate the analysis. Additionally or alternatively, the CNN model server 106 may communicate with a fraud evaluation server 104 to initiate one or more network security countermeasures based on the detection of a merchant breach.

Although the disclosure has been described in detail for the purpose of illustration based on what is currently considered to be the most practical and non-limiting embodiments, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method comprising:
receiving, with at least one processor, transaction data associated with a plurality of transactions by a plurality of payment devices in a first time period subsequent to the plurality of payment devices transacting with a merchant;
identifying, with at least one processor, based on inputting at least one parameter of the transaction data into a fraud evaluation model, a set of suspected fraudulent transactions of the plurality of transactions;
generating, with at least one processor, an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and
detecting, with at least one processor, breach of the merchant by processing the image with a convolutional neural network (CNN) model.

2. The computer-implemented method of claim 1, wherein the at least one parameter comprises at least one of the following: chargeback data; reported fraud data; decline data; or any combination thereof.

3. The computer-implemented method of claim 1, wherein a y-axis position in the image of each point in the field of points is associated with an index of a payment device of the plurality of payment devices.

4. The computer-implemented method of claim 3, further comprising:
generating, with at least one processor, a plurality of permuted images by randomly altering indexes of the plurality of payment devices for each of the plurality of permuted images to rearrange the y-axis position of each point in the field of points of each of the plurality of permuted images; and
detecting, with at least one processor, the breach of the merchant by processing each of the plurality of permuted images with the CNN model.

5. The computer-implemented method of claim 1, wherein detecting the breach of the merchant further comprises assigning a breach likelihood score to the image using the CNN model and comparing the breach likelihood score to a threshold score generated from evaluations of transaction data from previous time periods and other merchants.

6. The computer-implemented method of claim 5, further comprising:
generating, with at least one processor, display data configured to cause a computing device to display a user interface depicting the breach likelihood score, the image visually adjacent a time scale, and a visual indicator of where in the image the breach occurred; and
communicating, with at least one processor, the display data to a computing device of the merchant.

7. The computer-implemented method of claim 1, further comprising, in response to detecting the breach of the merchant, initiating, with at least one processor, a network security countermeasure comprising at least one of the following: declining transactions with the merchant; freezing at least one transaction account associated with at least one payment device of the plurality of payment devices; communicating alerts to users of the plurality of payment devices; or any combination thereof.

8. The computer-implemented method of claim 1, wherein an intensity value of each point of the field of points is based on a number of suspected fraudulent transactions associated with a payment device having occurred in a given time subperiod.

9. A system comprising a server comprising at least one processor, the server being programmed and/or configured to:
receive transaction data associated with a plurality of transactions by a plurality of payment devices in a first time period subsequent to the plurality of payment devices transacting with a merchant;
identify, based on inputting at least one parameter of the transaction data into a fraud evaluation model, a set of suspected fraudulent transactions of the plurality of transactions;
generate an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and
detect breach of the merchant by processing the image with a convolutional neural network (CNN) model.

10. The system of claim 9, wherein a y-axis position in the image of each point in the field of points is associated with an index of a payment device of the plurality of payment devices.

11. The system of claim 10, wherein the server is further programmed and/or configured to:
generate a plurality of permuted images by randomly altering indexes of the plurality of payment devices for each of the plurality of permuted images to rearrange the y-axis position of each point in the field of points of each of the plurality of permuted images; and
detect the breach of the merchant by processing each of the plurality of permuted images with the CNN model.

12. The system of claim 9, wherein detecting the breach of the merchant further comprises assigning a breach likelihood score to the image using the CNN model and comparing the breach likelihood score to a threshold score generated from evaluations of transaction data from previous time periods and other merchants.

13. The system of claim 12, wherein the server is further programmed and/or configured to:
generate display data configured to cause a computing device to display a user interface depicting the breach likelihood score, the image visually adjacent a time scale, and a visual indicator of where in the image the breach occurred; and
communicate the display data to a computing device of the merchant.

14. The system of claim 9, wherein the server is further programmed and/or configured to, in response to detecting the breach of the merchant, initiate a network security countermeasure comprising at least one of the following: declining transactions with the merchant; freezing at least one transaction account associated with at least one payment device of the plurality of payment devices; communicating alerts to users of the plurality of payment devices; or any combination thereof.

15. A computer program product comprising at least one non-transitory computer-readable medium including program instructions that, when executed by at least one processor, cause the at least one processor to:
receive transaction data associated with a plurality of transactions by a plurality of payment devices in a first time period subsequent to the plurality of payment devices transacting with a merchant;
identify, based on inputting at least one parameter of the transaction data into a fraud evaluation model, a set of suspected fraudulent transactions of the plurality of transactions;
generate an image comprising a field of points, wherein each point of the field of points is associated with at least one transaction of the set of suspected fraudulent transactions, and wherein an x-axis position in the image of each point in the field of points is associated with a time subperiod of the first time period in which the at least one transaction occurred; and
detect breach of the merchant by processing the image with a convolutional neural network (CNN) model.

16. The computer program product of claim 15, wherein a y-axis position in the image of each point in the field of points is associated with an index of a payment device of the plurality of payment devices.

17. The computer program product of claim 16, wherein the program instructions further cause the at least one processor to:
generate a plurality of permuted images by randomly altering indexes of the plurality of payment devices for each of the plurality of permuted images to rearrange the y-axis position of each point in the field of points of each of the plurality of permuted images; and
detect the breach of the merchant by processing each of the plurality of permuted images with the CNN model.

18. The computer program product of claim 15, wherein detecting the breach of the merchant further comprises assigning a breach likelihood score to the image using the CNN model and comparing the breach likelihood score to a threshold score generated from evaluations of transaction data from previous time periods and other merchants.

19. The computer program product of claim 18, wherein the program instructions further cause the at least one processor to:
generate display data configured to cause a computing device to display a user interface depicting the breach likelihood score, the image visually adjacent a time scale, and a visual indicator of where in the image the breach occurred; and
communicate the display data to a computing device of the merchant.

20. The computer program product of claim 15, wherein the program instructions further cause the at least one processor to, in response to detecting the breach of the merchant, initiate a network security countermeasure comprising at least one of the following: declining transactions with the merchant; freezing at least one transaction account associated with at least one payment device of the plurality of payment devices; communicating alerts to users of the plurality of payment devices; or any combination thereof.
